(19) United States
(12) Patent Application Publication
(10) Pub. No.: US 2021/0216024 A1
(43) Pub. Date: Jul. 15, 2021

(54) ELECTROPHOTOGRAPHIC PHOTOCONDUCTOR, METHOD OF MANUFACTURING THE SAME, AND METHOD OF MANAGING THE SAME

(71) Applicant: FUJI ELECTRIC CO., LTD., Kawasaki-shi (JP)

(72) Inventor: Toshiki OBINATA, Azumino-city (JP)

(73) Assignee: FUJI ELECTRIC CO., LTD., Kawasaki-shi (JP)

(21) Appl. No.: 17/107,352

(22) Filed: Nov. 30, 2020

(30) Foreign Application Priority Data
Jan. 10, 2020 (JP) 2020-002896

(51) Int. Cl. G03G 5/047; G03G 5/043; G03G 5/14

(52) U.S. Cl. CPC G03G 5/047; G03G 5/142; G03G 5/0436

(57) ABSTRACT

An electrophotographic photoconductor, including a substrate of a cylindrical shape, an organic photosensitive layer formed on an outer peripheral surface of the substrate, and a two-dimensional code provided on the outer peripheral surface of the substrate between the substrate and the organic photosensitive layer, at at least one axial end of the substrate. The two-dimensional code encodes identification information, and is formed outside an image formation region of the electrophotographic photoconductor. The two-dimensional code includes a first part and a second part satisfying 15≤ΔL1≤20, wherein ΔL1 is a difference between an L-value of the first part and that of the second part in a Lab color space. The outer peripheral surface of the substrate and the organic photosensitive layer satisfy ΔL2≤60, wherein ΔL2 is a difference between an L-value of the outer peripheral surface of the substrate and an L-value of the organic photosensitive layer in the Lab color space.

### CROSS-REFERENCE TO RELATED APPLICATION

This application is based upon and claims the benefit of priority of the prior Japanese Patent Application No. 2020-002896, filed on Jan. 10, 2020, the entire contents of which are incorporated herein by reference.

### TECHNICAL FIELD

The present invention relates to an electrophotographic photoconductor (hereinafter also simply referred to as a “photoconductor”) used in image formation devices such as electrophotographic printers, copiers, and fax machines, and improvement of a method of manufacturing the same and a method of managing the same.

### BACKGROUND ART

An electrophotographic photoconductor in which a functional layer including a photosensitive layer is formed on the outer peripheral surface of a cylindrical substrate is generally employed in an image formation device employing an electrophotographic method. A characteristic of the photosensitive layer in an electrophotographic photoconductor with such a structure may vary from one photoconductor to another depending on a state of the substrate and a condition during formation. In such a case, an image characteristic of an image formation device mounted with such a photoconductor is also affected. Accordingly, an image formation device needs to be mounted with an electrophotographic photoconductor custom-designed for the device.

For example, a technique of providing an individual identification code on a spigot part provided at an axial end of the inner peripheral part of a tubular substrate is proposed as an individual identification method of a photoconductor (Patent Documents 1 and 2). However, in this case, since an identification code is formed on the inner peripheral surface of the substrate, there is a problem that individual identification becomes difficult when drive flanges are attached to both ends of the photoconductor.

On the other hand, Patent Document 3 proposes a technology of providing one or more machining lines across the outer peripheral surface of a cylindrical substrate in a circumferential direction. The technology allows identification after flanges are attached to a photoconductor but there is a problem that it is insufficient when the number of items is increased or detailed individual identification is performed, due to a small amount of provided information.

Furthermore, Patent Document 4 describes recording, in a barcode form, individual identification information for individual identification provided on an electrophotographic photoconductor.

### RELATED ART DOCUMENTS

### Patent Documents

Patent Document 1: WO 2008/078783

Patent Document 2: JP2009-048206A

Patent Document 3: JP2017-097020A

Patent Document 4: JP2001-100616A

### SUMMARY OF THE INVENTION

### Problems to be Solved by the Invention

However, the conventional technologies have not been able to perform detailed individual identification of a photoconductor during each step of manufacture of the photoconductor and assembly of the manufactured photoconductor into an image formation device or the like. Accordingly, there is a demand for a technology capable of reliably performing more detailed individual identification of a photoconductor not only during manufacture but also after flange attachment.

In view of the above, an object of the present invention is to solve the aforementioned problems and to provide an electrophotographic photoconductor that can be managed in more detail by individual identification during either step of manufacture and assembly of the photoconductor without substantially affecting image quality, a method of manufacturing the same, and a method of managing the same.

### Means for Solving the Problems

As a result of intensive studies, the present inventor found that the following structures can solve the aforementioned problems.

Specifically, a first aspect of the present invention is an electrophotographic photoconductor including:

a substrate of a cylindrical shape having two axial ends;

an organic photosensitive layer formed on the outer peripheral surface of the substrate;

a two-dimensional code provided on the outer peripheral surface of the substrate between the substrate and the organic photosensitive layer, at either one or both of the two axial ends of the substrate, wherein

the two-dimensional code encodes identification information, and is formed outside an image formation region of the electrophotographic photoconductor;

the two-dimensional code includes a pattern that has a first part and a second part, the first and second parts satisfying 15>ΔL1≤20, wherein
ΔL1=Lb−Ld,
Lb denotes an L-value of the first part in a Lab color space, and
Ld denotes an L-value of the second part in the Lab color space; and

the outer peripheral surface of the substrate and the organic photosensitive layer satisfy ΔL2≤60, wherein
ΔL2=Ls−Lp,
Ls denotes an L-value of the outer peripheral surface of the substrate in the Lab color space and
Lp denotes an L-value of the organic photosensitive layer in the Lab color space.

The identification information may include specification information of the organic photosensitive layer and may further include specification information of the electrophotographic photoconductor. The identification information may include specification information of the electrophotographic photoconductor.

The two-dimensional code may be a Quick Response (QR) code. The second part of the two-dimensional code may be darker than the first part.

A second aspect of the present invention is a method of manufacturing the aforementioned electrophotographic photoconductor, the method including:

a code formation process of forming the two-dimensional code on the outer peripheral surface of the substrate, at either one or both of the two axial ends of the substrate, and outside the image formation region of the electrophotographic photoconductor;

a code reading process of reading the two-dimensional code to obtain the identification information; and a photosensitive layer formation step of forming the organic photosensitive layer on the outer peripheral surface of the substrate with the two-dimensional code formed thereon, based on the identification information.

The two-dimensional code may be a Quick Response (QR) code.

A third aspect of the present invention is a method of managing the aforementioned electrophotographic photoconductor, the method including:

a code reading process of reading the two-dimensional code to obtain the identification information; and

an assembly process of assembling the electrophotographic photoconductor into a process cartridge or an image formation device based on the identification information.

The two-dimensional code may be a Quick Response (QR) code.

### Effects of the Invention

According to the aforementioned aspects of the present invention, an electrophotographic photoconductor that can be managed in more detail by individual identification during either step of manufacture and assembly of the photoconductor without substantially affecting image quality, a method of manufacturing the same, and a method of managing the same can be provided. Accordingly, the present invention enables accurate individual identification of an electrophotographic photoconductor supporting multi-item production and can more effectively prevent occurrence of defective items caused by mistakes in a type and/or an application condition of a coating liquid in a production process and mixing of a different type of photoconductor in an assembly process.

### BRIEF DESCRIPTION OF THE DRAWINGS

FIG. 1 is a schematic perspective view illustrating an electrophotographic photoconductor according to the present invention.

FIG. 2 is an enlarged partial cross-sectional view along a line X-X at an axial end of the electrophotographic photoconductor illustrated in FIG. 1.

FIG. 3 is a schematic cross-sectional view illustrating a structure example of the electrophotographic photoconductor according to the present invention.

### MODE FOR CARRYING OUT THE INVENTION

Specific embodiments of the present invention will be described in detail below by use of drawings. The present invention is not in the least limited by the following description.

### (Electrophotographic Photoconductor)

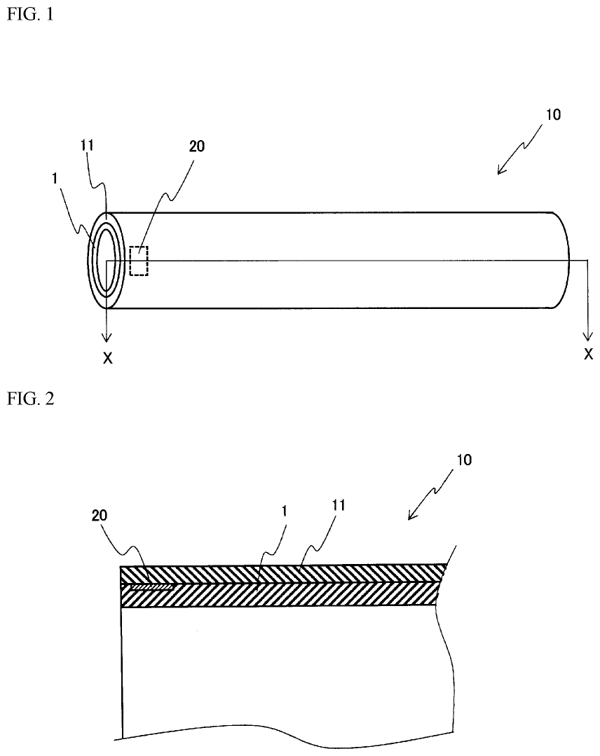

FIG. 1 is a schematic perspective view illustrating an electrophotographic photoconductor according to the present invention. FIG. 2 is an enlarged partial cross-sectional view along a line X-X at an axial end of the electrophotographic photoconductor illustrated in FIG. 1. As illustrated, a photoconductor 10 according to the present invention includes at least an organic photosensitive layer 11 on the outer peripheral surface of a cylindrical substrate 1. In the present invention, a two-dimensional code, e.g., a Quick Response (QR) code 20 in which individual identification information is coded is provided between the substrate 1 and the organic photosensitive layer 11, and at either one or both of axial ends (one end in the illustrated example) of the outer peripheral surface of the substrate 1 out of an image formation region.

Providing the QR code 20 on the outer peripheral surface of the substrate 1 out of the image formation region enables individual identification of the substrate 1 or the photoconductor 10 using the QR code 20, without substantially affecting image formation. Further, since the QR code 20 is provided on the outer peripheral surface of the substrate 1, individual identification does not become difficult even when drive flanges are attached at both ends of the photoconductor. Furthermore, use of the QR code 20 capable of recording a larger amount of information enables recording of detailed individual identification information unlike the case of providing conventional machining lines, and therefore detailed individual identification can be performed for each of different types of substrates or photoconductors. In addition, since the QR code 20 can be determined by a detection device, misuse and/or mixing of a different item can be more reliably prevented compared with a case of an operator making a determination by visual observation, or the like. Accordingly, more detailed and reliable individual identification management can be performed during either step of manufacture and assembly of the photoconductor.

Here, the “image formation region” refers to a region on a photoconductor surface being in contact with a development machine or the like and being used for image formation when the photoconductor is mounted on an image formation device. For example, the image formation region corresponds to a region excluding a range from 0 mm to 10 mm from both axial ends of the substrate 1.

It is assumed in the present invention that a ΔL1 value expressed as the difference Lb−Ld between Lb denoting an L-value in a Lab color space of a bright part and Ld denoting an L-value in a Lab color space of a dark part among bright-dark parts constituting a pattern of the QR code 20 satisfies 15≤ΔL1≤20. By the ΔL1 value satisfying the above relation, the QR code 20 can be read accurately. The L-value can be measured by the use of a commercially available chromoscope.

It is further assumed in the present invention that a ΔL2 value expressed by the difference Ls−Lp between Ls denoting an L-value in a Lab color space of the outer peripheral surface of the substrate 1 and Lp denoting an L-value in a Lab color space of the organic photosensitive layer 11 provided on the outer peripheral surface of the substrate 1 satisfies ΔL2≤60. By the ΔL2 value satisfying the above relation, the QR code 20 can be read reliably through the organic photosensitive layer 11. It is particularly preferable that the ΔL2 value satisfy 15≤ΔL2≤60 in order to more reliably guarantee readability of the QR code 20 while guaranteeing a photoconductor characteristic. The value of Ls and the value of Lb may be different or may be substantially the same.

Accordingly, in the present invention, by the ΔL1 value and the ΔL2 value satisfying the above relations, individual identification of the substrate 1 or the photoconductor 10 during manufacture and during assembly can be performed reliably and accurately.

Examples of individual identification information recorded in the QR code 20 in the present invention include specification information of the organic photosensitive layer 11 formed on the substrate 1 and specifically, information such as a component and a thickness of each layer included in the organic photosensitive layer 11, and a coating liquid to be used and an application condition. By using such individual identification information, for example, when an undercoating layer, a charge generation layer, and a charge transport layer are successively provided on the substrate 1 during manufacture of the photoconductor, reading the QR code 20 before forming each layer facilitates successive formation of the layers in a correct order using a correct material.

Examples of the individual identification information recorded in the QR code 20 in the present invention further include specification information of the photoconductor and specifically, information such as a layer structure, a photoconductor characteristic, a type of a drive gear to be equipped, and a type of a cartridge or an image formation device to be used. By using such individual identification information, previously reading the QR code 20 facilitates selection of a suitable photoconductor during assembly of the photoconductor to a process cartridge or an image formation device.

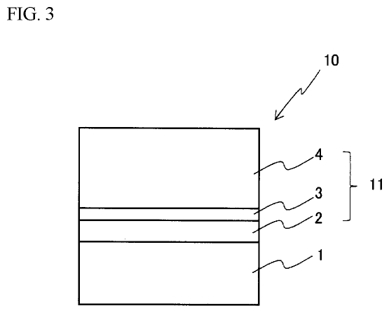

FIG. 3 is a schematic cross-sectional view illustrating a structure example of the electrophotographic photoconductor according to the present invention and illustrates a negatively charged multilayer photoconductor. In the illustrated negatively charged multilayer electrophotographic photoconductor, an undercoating layer 2, a charge generation layer 3 having a charge generation function, and a charge transport layer 4 having a charge transport function are successively laminated on the outer peripheral surface of the cylindrical substrate 1. The undercoating layer 2 may be provided as needed, and a surface protection layer may be provided on the charge transport layer 4.

While the charge generation layer 3 and the charge transport layer 4 form a multilayer photosensitive layer in the illustrated negatively charged multilayer electrophotographic photoconductor, it is assumed in the present invention for convenience that all layers formed on the substrate 1 including the undercoating layer 2 and the surface protection layer, when included in addition to the charge generation layer 3 and the charge transport layer 4, constitute the organic photosensitive layer 11.

The photosensitive layer contains a charge generation material, a hole transport material or an electron transport material as a charge transport material, and a resin binder as main components and further contains various additives as needed. The photosensitive layer according to the present invention is not limited to the illustrated example; and the photosensitive layer may be constituted of a single-layer photosensitive layer having both functions of charge generation and charge transport in a single layer and being mainly used in a positively charged type or may be constituted of a positively charged multilayer photosensitive layer in which a charge transport layer having the charge transport function and a charge generation layer having the charge generation function and the charge transport function are successively laminated; and thus the photosensitive layer is not particularly limited.

The substrate 1 has conductivity on the surface, serves as an electrode of the photoconductor, and at the same time, functions as a support of the layers constituting the photoconductor. Examples of a material of the substrate 1 that may be used include a metal such as aluminum, stainless steel, and nickel, or glass or resin undergoing conductive treatment on the surface. An aluminum alloy material is particularly suitable as the substrate 1 from a viewpoint of ease of surface cutting and laser processing.

The undercoating layer 2 is constituted of a layer having resin as a main component or a metal oxide film such as anodized aluminum. The undercoating layer 2 is provided as needed for the purpose of controlling a charge injection property from the substrate 1 to the photosensitive layer, covering a defect on the surface of the substrate 1, enhancement of adhesiveness between the photosensitive layer and the substrate 1, or the like. Examples of a resin material used in the undercoating layer 2 include insulating polymers such as casein, polyvinyl alcohol, polyamide, melamine, and cellulose, and conductive polymers such as polythiophene, polypyrrole, and polyaniline; and the resins may be used singly or in combination as appropriate. The resins containing a metal oxide such as titanium dioxide or zinc oxide may also be used.

In the illustrated negatively charged multilayer photoconductor, the charge generation layer 3 is formed by a method such as applying a coating liquid obtained by dispersing charge generation material particles in a resin binder, and generates charges by receiving light. It is important that the charge generation layer 3 has high charge generation efficiency and high injection property of generated charges to the charge transport layer 4, and it is desirable that the charge generation layer 3 has low electric field dependence and has good injection property even in a low electric field.

Examples of the charge generation material in the charge generation layer 3 that may be used singly or in combination as appropriate include phthalocyanine compounds such as X-type metal-free phthalocyanine, τ-type metal-free phthalocyanine, α-type titanyl phthalocyanine, β-type titanyl phthalocyanine, Y-type titanyl phthalocyanine, γ-type titanyl phthalocyanine, amorphous-type titanyl phthalocyanine, and ε-type copper phthalocyanine, various types of azo pigments, anthanthrone pigments, thiapyrylium pigments, perylene pigments, perinone pigments, squarylium pigments, and quinacridone pigments; and a suitable substance can be selected according to a light wavelength region of an exposure light source used in image formation. The charge generation layer 3 may contain a charge generation material as a main component, and a charge transport material or the like may be added thereto.

Examples of the resin binder in the charge generation layer 3 that may be used in combination as appropriate include polymers and copolymers of polycarbonate resin, polyester resin, polyamide resin, polyurethane resin, vinyl chloride resin, vinyl acetate resin, phenoxy resin, polyvinyl acetal resin, polyvinyl butyral resin, polystyrene resin, polysulfone resin, diallyl phthalate resin, and methacrylate resin.

The content of the charge generation material in the charge generation layer 3 relative to the solid content in the charge generation layer 3 is preferably 20 to 80% by mass and is more preferably 30 to 70% by mass. The content of the resin binder in the charge generation layer 3 relative to the solid content in the charge generation layer 3 is preferably 20 to 80% by mass and is more preferably 30 to 70% by mass.

Since the charge generation layer 3 has only to have the charge generation function, the film thickness thereof is determined by an optical absorption coefficient of the charge generation material, and the thickness is generally equal to or less than 1μm and is preferably equal to or less than 0.5μm.

In the negatively charged multilayer photoconductor, the charge transport layer 4 is mainly constituted of a charge transport material and a resin binder.

Examples of the charge transport material in the charge transport layer 4 that may be used singly or in combination as appropriate include various hydrazone compounds, styryl compounds, diamine compounds, butadiene compounds, and indole compounds. Examples of such a charge transport material include (II-1) to (II-14) below but are not limited thereto.

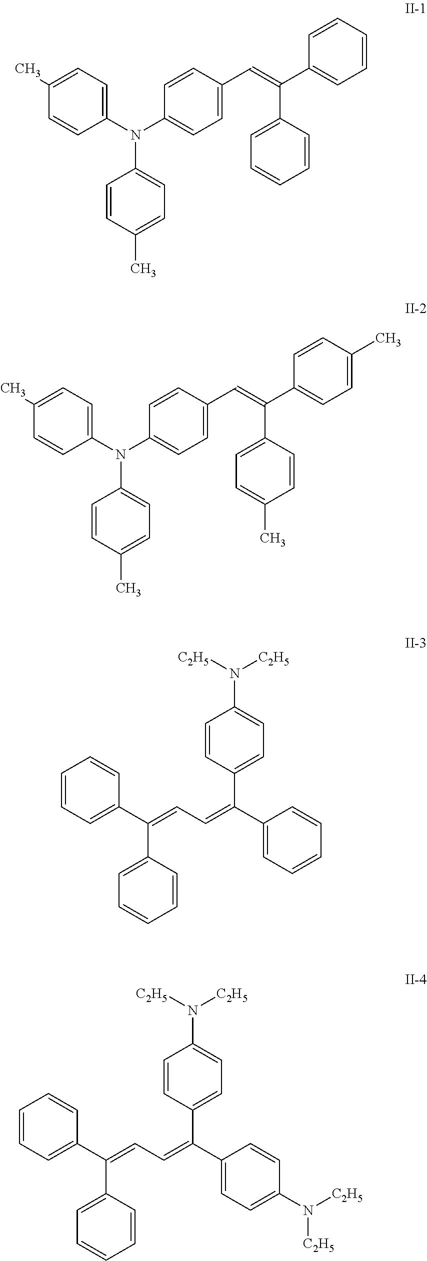

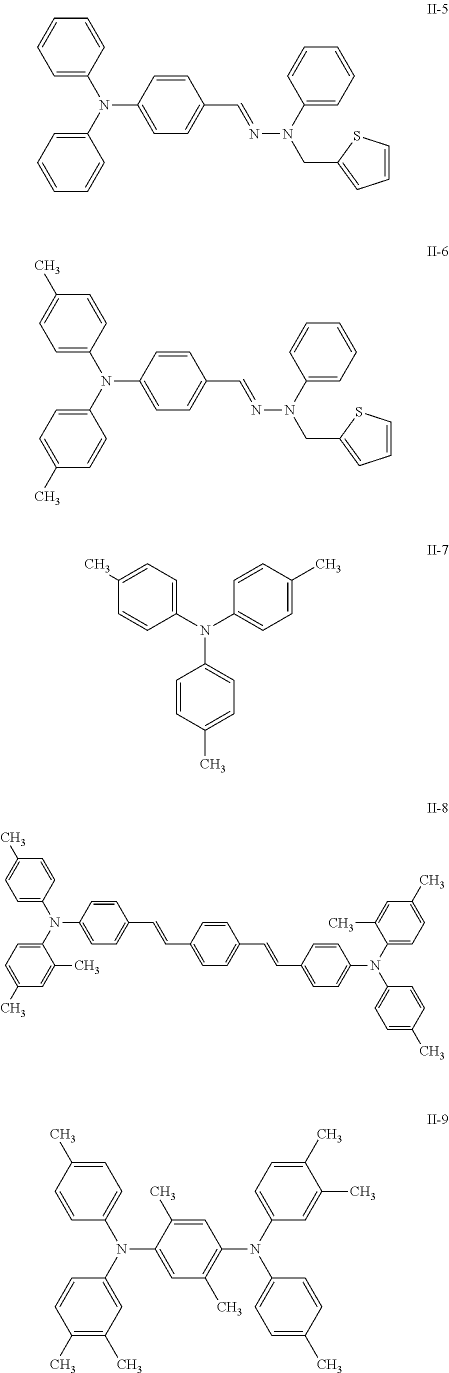

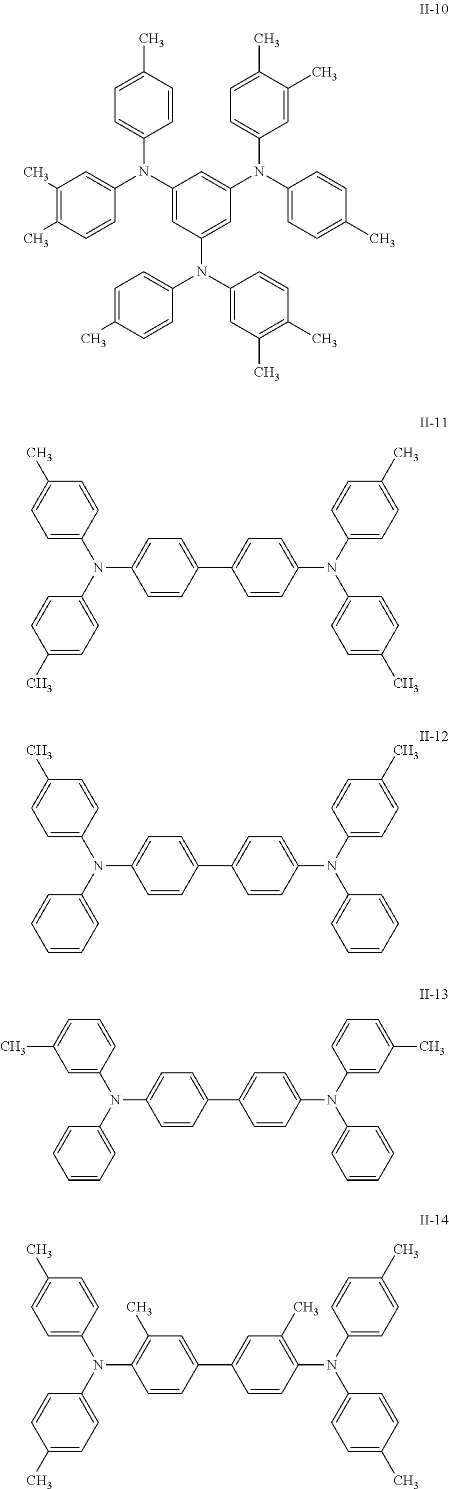

Examples of the resin binder in the charge transport layer 4 that may be used include polyarylate resin, various polycarbonate resins such as bisphenol A, bisphenol Z, a bisphenol A-biphenyl copolymer, and a bisphenol Z-biphenyl copolymer, polyphenylene resin, polyester resin, polyvinyl acetal resin, polyvinyl butyral resin, polyvinyl alcohol resin, vinyl chloride resin, vinyl acetate resin, polyethylene resin, polypropylene resin, acrylic resin, polyurethane resin, epoxy resin, melamine resin, silicone resin, polyamide resin, polystyrene resin, polyacetal resin, polysulfone resin, methacrylate polymers and copolymers thereof. Furthermore, resins of the same type having different molecular weights may be used in combination.

The content of the resin binder in the charge transport layer 4 relative to the solid content in the charge transport layer 4 is preferably 10 to 90% by mass and is more preferably 20 to 80% by mass. The content of the charge transport material in the charge transport layer 4 relative to the solid content in the charge transport layer 4 is preferably 10 to 90% by mass and is more preferably 20 to 80% by mass.

In order to maintain practically effective surface potential, the film thickness of the charge transport layer 4 is preferably in a range from 3 to 50μm and is more preferably in a range from 15 to 40μm.

An antidegradant such as an antioxidant or a light stabilizer may be contained in the aforementioned photosensitive layer for the purpose of enhancing environmental resistance and stability against harmful light. Examples of compounds used for such a purpose include chromanol derivatives such as tocopherol, esterified compounds, polyarylalkane compounds, hydroquinone derivatives, etherified compounds, dietherified compounds, benzophenone derivatives, benzotriazole derivatives, thioether compounds, phenylenediamine derivatives, phosphonates, phosphites, phenol compounds, hindered phenol compounds, linear amine compounds, cyclic amine compounds, and hindered amine compounds.

Further, a leveling agent such as silicone oil or fluorine-based oil may be contained in the aforementioned photosensitive layer for the purpose of enhancing a leveling property of a formed film and imparting lubricity. Furthermore, a metal oxide such as silicon oxide (silica), titanium oxide, zinc oxide, calcium oxide, aluminum oxide (alumina), or zirconium oxide, a metal sulfate such as barium sulfate or calcium sulfate, fine particles of metal nitride such as silicon nitride or aluminum nitride, particles of fluorine-based resin such as 4-fluoroethylene resin, fluorine-based combshaped graft polymer resin, or the like may be contained for the purpose of adjusting film hardness, reducing a friction coefficient, imparting lubricity, and the like. In addition, other known additives may be contained as needed, without remarkable impairment of an electrophotographic characteristic.

The ΔL2 value of the organic photosensitive layer 11 varies from one mounted device to another even when the same substrate 1 is used because types and thicknesses of the undercoating layer 2, the charge generation layer 3, the charge transport layer 4, and the like need to be adjusted for each mounted device in order to obtain photoconductor characteristics suited to various devices. In other words, the ΔL2 value in the present invention can be controlled by adjusting the material and film thickness of each layer constituting the organic photosensitive layer 11. The component material and thickness of the charge generation layer 3 in particular significantly affect the ΔL2 value in a negatively charged multilayer electrophotographic photoconductor. The thickness of the charge generation layer 3 according to the present invention is preferably equal to or greater than 0.05μm and equal to or less than 1μm and is more preferably equal to or greater than 0.1μm and equal to or less than 0.5μm from a viewpoint of obtaining a photoconductor in which the ΔL2 value satisfies the aforementioned relation. From a similar viewpoint, the mass ratio between the charge generation material and the resin binder in the solid content in the charge generation layer 3 (mass of the charge generation material/mass of the resin binder) is preferably 3/7 to 8/2 and is more preferably 4/6 to 7/3.

### (Method of Manufacturing Electrophotographic Photoconductor)

In a method of manufacturing the electrophotographic photoconductor according to the present invention, the QR code 20 is formed at a predetermined position on the outer peripheral surface of the substrate 1 used for the photoconductor prior to forming the organic photosensitive layer 11 on the outer peripheral surface of the substrate 1. This enables suitable formation of a target organic photosensitive layer 11 on the substrate 1, based on individual identification information of the QR code 20.

Specifically, in the manufacturing method according to the present invention, the QR code 20 is first formed at a predetermined position at either one or both of the axial ends of the outer peripheral surface of the substrate 1 out of an image formation region (code formation process). The formation of the QR code 20 on the outer peripheral surface of the substrate 1 may be performed by a processing method of roughening the surface of the substrate 1, such as laser processing, sandblast processing, or an etching method. The laser processing is preferable for ease of work. While a part of the surface of the substrate 1 that becomes a dark part of the QR code is roughened in the formation of the QR code, a part that becomes a bright part may also be roughened in addition to the part that becomes the dark part. While the intended effect of the QR code 20 according to the present invention can be obtained by providing the code at either one of the axial ends of the substrate 1, the possibility of occurrence of reading errors can be further reduced by providing the code at both ends.

While the position where the QR code 20 is provided may be either one of the upper end side and the lower end side of the substrate 1 in the vertical direction at the time of dip coating in layer formation, it is preferable to provide the code on the upper end side because, when the code is provided on the lower end side, the reading of the QR code 20 may be affected by the occurrence of a puddle, a splash, or the like of a coating liquid for forming each of the undercoating layer, the charge generation layer, the charge transport layer, and the like.

Next, the QR code 20 on the outer peripheral surface of the substrate 1 is read through the organic photosensitive layer 11, and recorded individual identification information is obtained (code reading process); and then based on the individual identification information, the organic photosensitive layer 11 is formed on the outer peripheral surface of the substrate 1 where the QR code 20 is formed (photosensitive layer formation process). Reading of the QR code 20 may be mechanically performed by use of a detection device. The detection device to be used is not particularly limited as long as the device is capable of precisely reading the QR code 20. More specifically, when the organic photosensitive layer 11 is constituted of a plurality of layers, the QR code 20 is successively read from the lower layer side, layer formation is performed based on individual identification information obtained from the read QR code 20, and the organic photosensitive layer 11 can be formed by repeating the above for each layer; and then a target photoconductor can be obtained.

### (Method of Managing Electrophotographic Photoconductor)

In a method of managing the electrophotographic photoconductor according to the present invention, the photoconductor is assembled to a process cartridge or an image formation device by use of the QR code 20 formed on the outer peripheral surface of the aforementioned substrate 1. This enables suitable identification of the photoconductor based on individual identification information recorded in the QR code 20 and incorporation of the photoconductor into the device.

Specifically, in the management method according to the present invention, the QR code 20 on the outer peripheral surface of the substrate 1 is first read through the organic photosensitive layer 11, and recorded individual identification information is obtained (code reading process). The reading of the QR code 20 in this case can also be mechanically performed by use of a detection device, and the detection device to be used is not particularly limited as long as the device is capable of precisely reading the QR code 20. Subsequently, by assembling the photoconductor to a process cartridge or an image formation device, based on the obtained individual identification information (assembly process), a suitable photoconductor can be reliably incorporated for each device.

### EXAMPLES

The present invention will be described in more detail below by citing specific examples. The present invention is not limited by the following examples without departing from the spirit of the present invention.

### Example 1

First, a cylindrically formed uncut aluminum conductive substrate was prepared. Next, by cutting the outer surface of the uncut substrate, a substrate 1 of a photoconductor with surface roughness (Rt) of 1.2μm was produced. Next, a QR code 20 in which specification information of an organic photosensitive layer and specification information of a target photoconductor are coded as individual identification information of the photoconductor was formed by use of laser at an axial end on the upper end side in the vertical direction at the time of dip coating in layer formation out of axial ends of the outer peripheral surface of the substrate 1 out of an image formation region.

Ls denoting an L-value in a Lab color space of the outer peripheral surface of the substrate 1 was 93. Further, Lb denoting an L-value in a Lab color space of a bright part was 93 and Ld denoting an L-value in a Lab color space of a dark part was 73 among bright-dark parts constituting a pattern of the formed QR code 20, and aΔL1 value expressed by the difference Lb−Ld was 20.

A colorimeter/color difference meter CR-400 from Konica Minolta, Inc. was used in the measurements of the L-values. As for the measurements of Ls and Lp out of the L-values, the measurements were performed at the total of nine points by taking three points in the axial direction of the substrate, that is, points respectively positioned 20 mm from the upper end and the lower end, and a point in the center part, and taking three points 120° apart from one another in the circumferential direction of the substrate for each part in the axial direction, and the average value was taken as the L-value.

The obtained substrate 1 was ultrasonic cleaned in a degreasing tank containing a detergent (product name: ELEASE) at 45° C. Subsequently, a detergent (product name: Castrol) was sprayed at the surface of the substrate 1, the surface was scrubbed with a brush and was rinsed with warm pure water, and moisture was removed with a drying oven.

A coating liquid for forming the undercoating layer 2 was prepared by dissolving or dispersing 15 parts by mass of p-vinylphenol resin (product name: MARUKA LYNCUR from Maruzen Petrochemical Co., Ltd.), 10 parts by mass of N-butylated melamine resin (product name: U-VAN 2021 from Mitsui Chemicals, Inc.), and 75 parts by mass of aminosilane treated titanium oxide fine particles in a mixed solvent containing 750 parts by mass/150 parts by mass of methanol/butanol. The QR code 20 on the outer peripheral surface of the substrate 1 was read with a smartphone, and information about the undercoating layer 2 was confirmed. Based on the obtained information, the aforementioned substrate 1 was dipped in the coating liquid for the undercoating layer and was subsequently withdrawn from the liquid, and a coating film was formed on the outer peripheral surface of the substrate. The undercoating layer 2 with a film thickness of 3μm was formed by drying the substrate at a temperature of 140° C. for 30 minutes.

Next, a coating liquid for forming the charge generation layer 3 was prepared by dispersing 15 parts by mass of Y-type titanyl phthalocyanine as a charge generation material described in JPS64-17066A and 15 parts by mass of polyvinyl butyral (product name: S-LEC B BX-1 from Sekisui Chemical Co., Ltd.) as a resin binder in 600 parts by mass of dichloromethane for one hour in a sand mill disperser. The QR code 20 on the outer peripheral surface of the substrate 1 was read with a smartphone, and information about the charge generation layer 3 was confirmed. Based on the obtained information, the coating liquid for the charge generation layer was dip coated on the aforementioned undercoating layer 2 and was dried at a temperature of 80° C. for 30 minutes, and the charge generation layer 3 with a film thickness of 0.3μm was formed.

Next, a coating liquid for forming the charge transport layer 4 was prepared by dissolving 130 parts by mass of polycarbonate resin as a resin binder and 70 parts by mass of a hole transport material (CTM) in 900 parts by mass of tetrahydrofuran and subsequently adding 3 parts by mass of silicone oil (product name: KP-340 from Shin-Etsu Polymer Co., Ltd.). The QR code 20 on the outer peripheral surface of the substrate 1 was read with a smartphone, and information about the charge transport layer 4 was confirmed. Based on the obtained information, the coating liquid for the charge transport layer was dip coated on the aforementioned charge generation layer 3 and was dried at a temperature of 130° C. for 60 minutes, and the charge transport layer 4 with a film thickness of 20μm was formed. A negatively charged multilayer electrophotographic photoconductor was produced by such a method.

Lp denoting an L-value in a Lab color space of the organic photosensitive layer 11 constituted of the undercoating layer 2, the charge generation layer 3, and the charge transport layer 4 provided on the outer peripheral surface of the aforementioned substrate 1 was 33, and the ΔL2 value expressed by the difference Ls−Lp was 60.

Next, in order to assemble drive gears, the QR code 20 on the outer peripheral surface of the substrate 1 of the aforementioned photoconductor was read, and information about the drive gear was confirmed. Based on the obtained information, drive gears were equipped at both ends of the aforementioned photoconductor.

Next, in order to assemble the aforementioned photoconductor to a cartridge, the QR code 20 on the outer peripheral surface of the substrate 1 of the photoconductor was read, and information about a cartridge to be used was confirmed. Based on the obtained information, the aforementioned photoconductor was assembled to the cartridge.

### Example 2

With respect to the photoconductor produced in Example 1, the color difference of the organic photosensitive layer 11 was changed by changing the thicknesses of each of the undercoating layer 2, the charge generation layer 3, and the charge transport layer 4 constituting the organic photosensitive layer 11, and evaluation was performed on whether the QR code provided on the outer peripheral surface of the substrate 1 can be read, in accordance with the following criteria. The result is indicated in Table 1 below.
O: Readable.
Δ: Sometimes unreadable.
x: Unreadable.

TABLE 1

| ΔL2 value | QR code reading status |
|---|---|
| 15 | ○ |
| 20 | ○ |
| 25 | ○ |
| 30 | ○ |
| 35 | ○ |
| 40 | ○ |
| 45 | ○ |
| 50 | ○ |
| 55 | ○ |
| 60 | ○ |
| 65 | Δ |
| 70 | x |

As a result, it was confirmed that reading errors are likely to occur when the ΔL2 value exceeds 60, as indicated in the above table. The above tells that ΔL2 value≤60 is required as the upper limit of the ΔL2 value.

### DESCRIPTION OF SYMBOLS

1 Substrate
2 Undercoating layer
3 Charge generation layer
4 Charge transport layer
10 Electrophotographic photoconductor
11 Organic photosensitive layer
20 QR code

1. An electrophotographic photoconductor, comprising:
a substrate of a cylindrical shape having two axial ends;
an organic photosensitive layer formed on an outer peripheral surface of the substrate;
a two-dimensional code provided on the outer peripheral surface of the substrate between the substrate and the organic photosensitive layer, at either one or both of the two axial ends of the substrate, wherein
the two-dimensional code encodes identification information, and is formed outside an image formation region of the electrophotographic photoconductor;
the two-dimensional code includes a pattern that has a first part and a second part, the first and second parts satisfying 15≤ΔL1≤20, wherein
ΔL1=Lb−Ld,
Lb denotes an L-value of the first part in a Lab color space, and
Ld denotes an L-value of the second part in the Lab color space; and
the outer peripheral surface of the substrate and the organic photosensitive layer satisfy ΔL2 ≤60, wherein
ΔL2=Ls−Lp,
Ls denotes an L-value of the outer peripheral surface of the substrate in the Lab color space, and
Lp denotes an L-value of the organic photosensitive layer in the Lab color space.

2. The electrophotographic photoconductor according to claim 1, wherein the identification information includes specification information of the organic photosensitive layer.

3. The electrophotographic photoconductor according to claim 2, wherein the identification information further includes specification information of the electrophotographic photoconductor.

4. The electrophotographic photoconductor according to claim 1, wherein the identification information includes specification information of the electrophotographic photoconductor.

5. The electrophotographic photoconductor according to claim 1, wherein the two-dimensional code is a Quick Response (QR) code.

6. The electrophotographic photoconductor according to claim 1, wherein the second part of the two-dimensional code is darker than the first part.

7. A method of manufacturing the electrophotographic photoconductor according to claim 2, the method comprising:
a code formation process of forming the two-dimensional code on the outer peripheral surface of the substrate, at either one or both of the two axial ends of the substrate, and outside the image formation region of the electrophotographic photoconductor;
a code reading process of reading the two-dimensional code to obtain the identification information; and
a photosensitive layer formation process of forming the organic photosensitive layer on the outer peripheral surface of the substrate with the two-dimensional code formed thereon, based on the identification information.

8. The method of manufacturing the electrophotographic photoconductor according to claim 7, wherein the two-dimensional code is a Quick Response (QR) code.

9. A method of managing the electrophotographic photoconductor according to claim 3, the method comprising:
a code reading process of reading the two-dimensional code to obtain the identification information; and
an assembly process of assembling the electrophotographic photoconductor to a process cartridge or an image formation device, based on the identification information.

10. The method of manufacturing the electrophotographic photoconductor according to claim 9, wherein the two-dimensional code is a Quick Response (QR) code.
